(19) United States
(12) Patent Application Publication
(10) Pub. No.: US 2021/0261837 A1
(43) Pub. Date: Aug. 26, 2021

(54) METHOD FOR APPLYING A COATING WITH ENHANCED ADHESION TO A COMPOSITE MATERIAL SUBSTRATE, AND COMPOSITE MATERIAL SUBSTRATE OR AIRCRAFT COMPRISING SUCH COATING

(71) Applicant: Airbus SAS, BLAGNAC (FR)

(72) Inventor: Richard FORSTER, BLAGNAC (FR)

(21) Appl. No.: 17/181,552

(22) Filed: Feb. 22, 2021

(30) Foreign Application Priority Data
Feb. 24, 2020 (FR) 2001785

(51) Int. Cl. C09J 179/02; B05D 7/00; C09J 11/04

(52) U.S. Cl. CPC C09J 179/02; C08K 3/042; C09J 11/04; B05D 7/54

(57) ABSTRACT

A method for applying a coating to at least one face of a substrate made of thermoplastic composite material, wherein the method includes a step of applying an adhesive polydopamine layer to the face of the substrate before applying the coating to enhance the adhesion of the coating to the substrate. A thermoplastic composite material substrate thus coated is provided. A method for applying a coating to a composite material panel forming part of the outer skin of an aircraft is provided, wherein a zinc or graphene particle-filled adhesive polydopamine layer is applied to the panel before the coating is applied to enhance the adhesion thereof to the panel. An aircraft comprising a panel thus coated is provided.

### CROSS-REFERENCES TO RELATED APPLICATIONS

This application claims the benefit of the French patent application No. 2001785 filed on Feb. 24, 2020, the entire disclosures of which are incorporated herein by way of reference.

### FIELD OF THE INVENTION

The present invention pertains to a method for applying a coating with enhanced adhesion to a substrate made of composite material, to a composite material substrate comprising such a coating, and to an aircraft comprising an outer skin at least partially covered with such a coating.

### BACKGROUND OF THE INVENTION

According to one embodiment, an aircraft comprises an outer skin composed of adjacent panels or metal sheets. At the end of assembly, the outer skin of the aircraft is covered with a coating whose functions include, in particular, those of esthetics and protection. This coating comprises at least one anchor layer promoting the adhesion of the coating to the outer skin, at least one anticorrosion layer, at least one paint layer, and, lastly, at least one varnish layer.

In order to reduce the mass of the aircraft, some panels of the fuselage are made of composite material with fibers, especially carbon fibers, embedded in a resin. Some of these panels may be made of thermoplastic composite material and may comprise a thermoplastic resin matrix, of the PEEK, PEKK, PAEK or PPS type, for example.

According to an embodiment illustrated in FIG. 1, a panel of composite material 10 is covered with a coating 12.

Because the thermoplastic resin gives the panel 10 a low surface energy, the anchor layer which is used for the metal panels does not enable satisfactory adhesion between the panel 10 and its coating 12.

One solution for promoting adhesion between the coating 12 and the panel 10 is to modify the surface of the panel 10 so as to increase its surface energy or its wettability. There are a number of surface treatments for this purpose, such as flame treatment, corona treatment, and plasma treatment. These surface treatments, however, are not easy to implement for the uniform treatment of large surface areas which are sensitive to heat and nonplanar, like the composite material panels of an aircraft fuselage.

It is an aim of the present invention to resolve some or all of the drawbacks of the prior art.

### SUMMARY OF THE INVENTION

For this purpose, the invention provides a method for applying a coating to at least one face of a substrate made of thermoplastic composite material, wherein the method comprises a first step of applying an adhesive polydopamine layer filled with particles of graphene or of zinc to the face of the substrate, then a second step of applying the coating to the zinc or graphene particle-filled adhesive polydopamine layer.

Using an adhesive polydopamine layer produces a high level of adhesion between the substrate and the coating, despite the low surface energy of the thermoplastic composite material substrate.

According to other features, taken in isolation or as a combination:

the adhesive polydopamine layer is applied in aqueous solution;

the adhesive polydopamine layer has a thickness of between 200 nm and 100 μm;

the adhesive polydopamine layer is filled with graphene and comprises from 0.5% to 2% by weight of graphene.

The invention also provides a substrate comprising, on at least one face, a coating, wherein the substrate comprises a zinc or graphene particle-filled adhesive polydopamine layer interposed between the face of the substrate and the coating.

The invention further provides a method for applying a coating to an outer face of an aircraft panel made of composite material, the panel being connected to a structure by at least one connecting element housed in an orifice through the panel, wherein the method comprises a first step of applying a zinc or graphene particle-filled adhesive polydopamine layer to the outer face of the panel, then a second step of applying the coating to the zinc or graphene particle-filled adhesive polydopamine layer.

According to another feature, each connecting element is covered by the zinc or graphene particle-filled adhesive polydopamine layer and the coating.

The invention additionally provides an aircraft comprising a panel made of composite material and having an outer face forming part of an outer skin of the aircraft, the panel being connected to a structure by at least one connecting element housed in an orifice through the panel, the outer face of the panel being covered by a coating, wherein the panel comprises a zinc or graphene particle-filled adhesive polydopamine layer interposed between the outer face and the coating.

According to another feature, a zinc or graphene particle-filled adhesive polydopamine layer is interposed between each connecting element and a wall of the orifice receiving it.

### BRIEF DESCRIPTION OF THE DRAWINGS

Other features and advantages will emerge from the description of the invention hereinafter, which is given solely by way of example, together with the appended drawings, in which:

FIG. 1 is a section through a composite material panel covered with a coating illustrating an embodiment of the prior art, and

FIG. 2 is a section through a composite material part covered with a coating illustrating an embodiment of the invention.

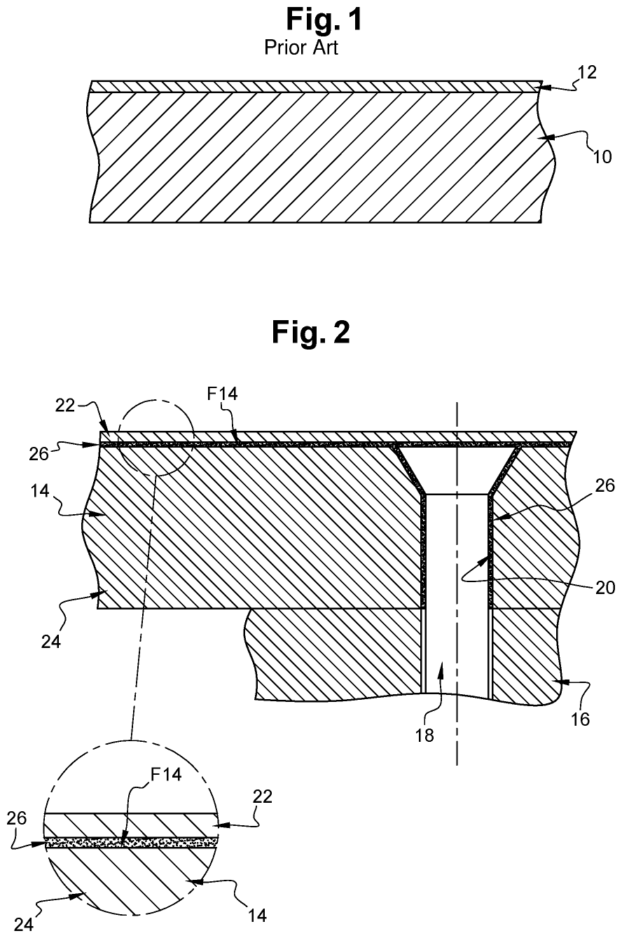

### DETAILED DESCRIPTION OF THE PREFERRED EMBODIMENTS

According to one embodiment, which can be seen in FIG. 2, a panel 14 is connected to a structure 16 by at least one connecting element 18 housed in an orifice 20 through the panel 14. This panel 14 has an outer face F14 which forms part of an outer skin of an aircraft.

According to an embodiment, the panel 14 is made of thermoplastic composite material. As an example, the panel 14 comprises carbon fibers embedded in a thermoplastic resin matrix, of PEEK, PEKK, PAEK or PPS type, for example.

The structure 16 may be metallic or made of composite material. The connecting element 18 is generally metallic.

The outer face F14 of the panel 14 is covered with a coating 22.

The invention is, of course, not limited to this application. It may be applied to any thermoplastic composite material substrate 24 at least partly covered with a coating 22.

This coating 22 comprises at least one paint or protective layer. According to an embodiment, the coating 22 comprises at least one anticorrosion layer, at least one paint layer, and at least one varnish layer. These different layers are applied in the same way as in the prior art.

The coating 22 is not described here in more detail, since it can be identical to those of the prior art.

According to one feature of the invention, an adhesive polydopamine layer 26 is used to connect the substrate 24 and the coating 22. Accordingly, the substrate 24 comprises a coating 22 and also an adhesive polydopamine layer 26 interposed between the substrate 24 and the coating 22.

The adhesive polydopamine layer 26 has a thickness of between 200 nm and 100 μm.

The method for applying the coating 22 to a face of a substrate 24 comprises a first step of applying an adhesive polydopamine layer 26 to the face of the substrate 24, then a second step of applying the coating 22 to the adhesive polydopamine layer 26. The connecting elements 18 present are also covered with the adhesive polydopamine layer 26 and with the coating 22.

According to one procedure, the application method comprises a preparatory step on the face of the substrate 24, such as a degrease, for example, before the step of applying the adhesive polydopamine layer 26. This latter layer may be applied in aqueous solution to the face of the substrate 24, by spraying, for example.

According to an embodiment, the adhesive polydopamine layer 26 is filled with graphene particles. The adhesive polydopamine layer 26 comprises 0.5% to 2% by weight of graphene. In one configuration, the graphene particles are present in the form of platelets.

By virtue of the graphene present, the adhesive polydopamine layer 26 is electrically and thermally conductive. The graphene present also gives the layer anticorrosion properties.

According to an embodiment, the adhesive polydopamine layer 26 is filled with zinc particles in order to endow it with anticorrosion properties and to obtain an anticorrosion barrier without either chromium or cadmium. In this embodiment, the adhesive polydopamine layer 26 comprises from 0.5% to 2% by weight of zinc.

According to another embodiment, the adhesive polydopamine layer 26 is filled with graphene particles and with zinc particles, to give an enhanced anticorrosion effect.

Using an adhesive polydopamine layer 26 produces a high level of adhesion between the substrate 24 and the coating 22, in spite of the low surface energy of the thermoplastic composite material substrate 24, without any need for a surface treatment such as a plasma treatment.

When the adhesive polydopamine layer 26 is filled with graphene, it forms an antilightning layer, which may assist or replace another antilightning layer such as a metallic mesh. Adding graphene to the adhesive polydopamine layer 26 is more effective than adding the same amount of graphene to the coating 22 in order to obtain an antilightning layer, since the thickness of the adhesive polydopamine layer 26 is significantly less than that of the coating 22 and allows a greater concentration of graphene to be obtained.

According to one procedure, the adhesive polydopamine layer 26 is applied not only to the outer face F14 but also to the wall of each orifice 20 provided for housing a connecting element 18. This solution enables electrical continuity between the panel 14 and the connecting element 18, and prevents the phenomenon of galvanic corrosion.

According to another advantage, coating the connecting elements 18 with an adhesive polydopamine layer 26 filled with graphene particles limits the risks of unscrewing and of loss of the connecting elements 18.

Coating the metal connecting elements 18 with the adhesive polydopamine layer 26 filled with zinc particles produces an anticorrosion barrier.

In another application, during the installation of each connecting element 18, an adhesive polydopamine layer 26 filled with zinc is interposed between the connecting element and the wall of the orifice 20 receiving it, this adhesive polydopamine layer 26 being applied to the connecting element 18 and/or to the wall of the orifice 20. This solution limits the risks of corrosion.

According to an embodiment, a composite material panel of the prior art, covered with a first coating, comprises a metallic mesh interposed between the panel and the first coating, forming an antilightning layer. A panel of this kind may have a damaged region on the surface, at which the metallic mesh and the first coating are no longer present. According to another advantage of the invention, a panel of this kind may be repaired by covering the damaged region with a graphene particle-filled adhesive polydopamine layer 26 and then with a second coating. Following the repair, the adhesive polydopamine layer 26 in contact with the metallic mesh ensures the continuity of the antilightning layer, while the second coating ensures the continuity of the first coating.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for applying a coating to at least one face of a substrate made of thermoplastic composite material, wherein the method comprises:
applying an adhesive polydopamine layer filled with particles of graphene or of zinc to the at least one face of the substrate, then
applying a coating to the zinc or graphene particle-filled adhesive polydopamine layer.

2. The method as claimed in claim 1, wherein the zinc or graphene particle-filled adhesive polydopamine layer is applied in aqueous solution.

3. The method as claimed in claim 1, wherein the zinc or graphene particle-filled adhesive polydopamine layer has a thickness of between 200 nm and 100 μm.

4. The method as claimed in claim 1, wherein the adhesive polydopamine layer is filled with graphene particles and comprises 0.5% to 2% by weight of graphene.

5. A substrate comprising, on at least one face:
a coating applied by implementing a method as claimed in claim 1,
wherein the substrate comprises a zinc or graphene particle-filled adhesive polydopamine layer interposed between the at least one face of the substrate and the coating.

6. A method for applying a coating to an outer face of an aircraft panel made of composite material, the panel being connected to a structure by at least one connecting element housed in an orifice through the panel, wherein the method comprises:
applying a zinc or graphene particle-filled adhesive polydopamine layer to the outer face of the panel, then
applying the coating to the zinc or graphene particle-filled adhesive polydopamine layer.

7. The method as claimed in claim 6, wherein each connecting element is covered by the zinc or graphene particle-filled adhesive polydopamine layer and the coating.

8. An aircraft comprising:
a panel made of composite material and having an outer face forming part of an outer skin of the aircraft,
the panel being connected to a structure by at least one connecting element housed in an orifice through the panel,
the outer face of the panel being covered by a coating applied by implementing a method as claimed in claim 6,
wherein the panel comprises a zinc or graphene particle-filled adhesive polydopamine layer interposed between the outer face and the coating.

9. The aircraft as claimed in claim 8, wherein a zinc or graphene particle-filled adhesive polydopamine layer is interposed between each connecting element and a wall of the orifice receiving it.
